(19) United States
(12) Patent Application Publication
(10) Pub. No.: US 2025/0192482 A1
(43) Pub. Date: Jun. 12, 2025

(54) SHIELD CONNECTOR, SHIELD CONNECTOR ASSEMBLY AND SHIELD CABLE

(71) Applicant: SUMITOMO WIRING SYSTEMS, LTD., Mie (JP)

(72) Inventors: Takahiro HASEGAWA, Mie (JP); Takeshi MISU, Mie (JP); Yutaka KOBAYASHI, Mie (JP)

(21) Appl. No.: 18/966,758

(22) Filed: Dec. 3, 2024

(30) Foreign Application Priority Data
Dec. 11, 2023 (JP) 2023-208574

(51) Int. Cl. H01R 13/6592; H01R 13/6582

(52) U.S. Cl. CPC H01R 13/6592; H01R 13/6582

(57) ABSTRACT

A shielded cable includes a shielded cable body including a core wire, an insulation coating, a shield member and a covering member, an underlay ring for covering an outer periphery of the covering member on a tip part of the covering member, an outer periphery of the underlay ring being covered by a folded portion of the shield member, and a shielding body to be connected to the folded portion. The shielding body includes a crimping portion formed into a tubular shape by a metal plate material and to be crimped to sandwich the folded portion by the underlay ring and the crimping portion, and a shell body portion formed with a leaf spring portion capable of being pressed into contact with an external GND member.

### CROSS-REFERENCE TO RELATED APPLICATIONS

This application is based on and claims priority from Japanese Patent Application No. 2023-208574, filed on Dec. 11, 2023, with the Japan Patent Office, the disclosure of which is incorporated herein in its entirety by reference.

### TECHNICAL FIELD

The present disclosure relates to a shield connector, a shield connector assembly and a shield cable.

### BACKGROUND

Conventionally, a shield connector is known which is provided with a shielded cable body including a shield member made of a braided wire or the like, and a fixed ferrule, a shielding body and a wave spring washer for connecting the shield member to an external GND member (see, for example, Publication of Japanese Patent No. 5559213). In this shield connector, the wave spring washer can be stably connected to the external GND member by being provided separately from the shielding body.

### SUMMARY

However, the shield connector as described above has a problem of complicated configuration. Specifically, the number of components is increased by providing the wave spring washer separately from the shielding body. Further, the shielding body was, for example, a cutting component. These cause an increase in the manufacturing cost of the shield connector.

The present disclosure aims to enable the simplification of a configuration of a shield connector while enabling stable connection to an external GND member.

This object is solved according to the invention by the features of the independent claims. Particular embodiments of the invention are subject of the dependent claims.

According to one aspect, there is provided a shield connector with a shielded cable body including at least one core wire, an insulation coating for at least partly covering an outer periphery of the core wire, a shield member for at least partly covering an outer periphery of the insulation coating and a covering member for at least partly covering an outer periphery of the shield member, at least one electrical terminal to be fixed to the core wire, an underlay ring for at least partly covering an outer periphery of the covering member on a tip part of the covering member, an outer periphery of the underlay ring being covered by a folded portion of the shield member, and a shielding body to be connected to the folded portion, the shielding body being electrically connectable to an external ground (GND) member, the shielding body including a connecting portion (particularly a crimping portion) substantially formed into a tubular shape by a conductive (particularly metal) plate material, the connecting portion sandwiching the folded portion by the underlay ring and the connecting portion, and a shell body portion formed with at least one (particularly leaf) spring portion capable of being pressed into contact with the external GND member, and the underlay ring including an underlay body portion provided at a position corresponding to the crimping portion and a large-diameter portion provided at a position substantially corresponding to a boundary between the connecting portion and the shell body portion, the large-diameter portion having a larger diameter than the underlay body portion.

According to a particular embodiment, there is provided a shielded cable body including a core wire, an insulation coating for covering an outer periphery of the core wire, a shield member for covering an outer periphery of the insulation coating and a covering member for covering an outer periphery of the shield member, an electrical terminal to be fixed to the core wire, an underlay ring for covering an outer periphery of the covering member on a tip part of the covering member, an outer periphery of the underlay ring being covered by a folded portion of the shield member, and a shielding body to be connected to the folded portion, the shielding body being electrically connectable to an external GND member, the shielding body including a crimping portion formed into a tubular shape by a metal plate material, the crimping portion being crimped to sandwich the folded portion by the underlay ring and the crimping portion, and a shell body portion formed with a leaf spring portion capable of being pressed into contact with the external GND member, and the underlay ring including an underlay body portion provided at a position corresponding to the crimping portion and a large-diameter portion provided at a position corresponding to a boundary between the crimping portion and the shell body portion, the large-diameter portion having a larger diameter than the underlay body portion.

Accordingly, since being formed into a tubular shape by the conductive (particularly metal) plate material, the shielding body can be easily manufactured, for example, as compared to the case where the shielding body is a cutting component.

Further, since the shielding body particularly includes the crimping portion to be crimped to sandwich the folded portion between the underlay ring and the crimping portion and the shell body portion formed with the leaf spring portion capable of being pressed into contact with the external GND member, the number of components is smaller, for example, as compared to a configuration including a separate wave spring washer.

Thus, the shield connector can have a simple configuration.

Since the underlay ring particularly includes the large-diameter portion at the position substantially corresponding to the boundary between the crimping portion and the shell body portion and having a larger diameter than the underlay body portion, the distortion of the shell body portion is suppressed particularly when the crimping portion is crimped.

Thus, the (particularly leaf) spring portion formed on the shell body portion can also be kept in proper shape.

As a result, the shielding body can be stably connected to the external GND member.

Particularly, the underlay ring may include an inclined portion having a diameter gradually reduced from the large-diameter portion toward the underlay body portion.

Accordingly, since the underlay ring particularly includes the inclined portion having the diameter gradually reduced from the large-diameter portion toward the underlay body portion, the shield member is less likely to be damaged, for example, as compared to a configuration not including the inclined portion.

That is, with an underlay ring not including the inclined portion, the shield member may be damaged by a corner of the large-diameter portion. However, this can be suppressed.

Further particularly, the underlay body portion may be set to have such a length as to project further outward than end part(s) of the folded portion and/or the connecting portion (particularly the crimping portion).

Accordingly, since the underlay body portion particularly is set to have such a length as to project further outward than the end part(s) of the folded portion and/or the connecting portion (particularly the crimping portion), the position of the underlay body portion can be grasped from outside.

Thus, it can be prevented that a pressure is applied to a part corresponding to the large-diameter portion, for example, when the crimping portion is crimped.

Therefore, the distortion of the shell body portion due to the application of a pressure to the part corresponding to the large-diameter portion is suppressed.

Further particularly, the shielding body may be mounted by being at least partly inserted into a connector housing, and the shell body portion may include at least one engaging portion engageable with the connector housing so as not to come out from the connector housing.

Accordingly to this configuration, since the shell body portion includes the at least one engaging portion engageable with the connector housing not to come out from the connector housing, the detachment of the shielding body from the connector housing can be suppressed.

Since the distortion of the shell body portion particularly is suppressed by the underlay ring including the large-diameter portion, the engaging portion can also be kept in proper shape.

As a result, the detachment of the shielding body from the connector housing is stably suppressed.

Further particularly, the shielding body may be mounted by being at least partly inserted into a connector housing, and the shell body portion may include at least one positioning portion engageable with the connector housing in an insertion direction into the connector housing for positioning the shielding body.

Accordingly, since the shell body portion particularly includes the at least one positioning portion engageable with the connector housing substantially in the insertion direction into the connector housing for positioning the shielding body, the shielding body can be arranged at an optimal mounting position.

Since the distortion of the shell body portion particularly is suppressed by the underlay ring including the large-diameter portion, the positioning portion can also be kept in proper shape.

As a result, the shielding body can be stably arranged at the optimal mounting position.

Further particularly, with the shielded cable at least partly inserted to a hole of the tube portion, the engaging portion is hooked to at least one respective protrusion of the housing, whereby the shielded cable is retained.

Further particularly, the shielding body may include a fitting portion in a circumferential part, end parts of the conductive (particularly metal) plate material being connected at the fitting portion, and the (leaf) spring portion particularly may be provided at a position substantially not overlapping the fitting portion in a circumferential direction.

Accordingly, the shielding body particularly includes the fitting portion, where the end part(s) of the conductive (particularly metal) plate material are connected, in the circumferential part.

Since the (particularly leaf) spring portion is provided at the position substantially not overlapping the fitting portion in the circumferential direction, the (leaf) spring portion can be easily provided without being affected by the fitting portion.

According to another aspect, there is provided a shield connector assembly comprising a shield connector according to the above aspect or a particular embodiment thereof and a mating connector including the external GND member to be electrically connected to the shielding body.

According to another aspect, there is provided a shielded cable comprising a shielded cable body including at least one core wire, an insulation coating for at least partly covering an outer periphery of the core wire, a shield for at least partly covering an outer periphery of the insulation coating and a covering member for at least partly covering an outer periphery of the shield member; an underlay ring for at least partly covering an outer periphery of the covering member on a tip part of the covering member, an outer periphery of the underlay ring being covered by a folded portion of the shield member; and a shielding body to be connected to the folded portion, the shielding body being electrically connectable to an external GND member, the shielding body including a connecting portion substantially formed into a tubular shape by a conductive plate material, the connecting portion sandwiching the folded portion by the underlay ring and the connecting portion, and a shell body portion formed with at least one spring portion capable of being pressed into contact with the external GND member, and the underlay ring including an underlay body portion provided at a position substantially corresponding to the connecting portion and a large-diameter portion provided at a position substantially corresponding to a boundary between the connecting portion and the shell body portion, the large-diameter portion having a larger diameter than the underlay body portion.

According to a particular embodiment, the underlay ring includes an inclined portion having a diameter gradually reduced from the large-diameter portion toward the underlay body portion, and/or wherein the underlay body portion is set to have such a length as to project further outward than end part(s) of the folded and/or the connecting portion.

Particularly, the shielding body is mounted by being at least partly inserted into a connector housing, and the shell body portion includes at least one engaging portion engageable with the connector housing so as not to come out from the connector housing, and/or the shell body portion includes at least one positioning portion engageable with the connector housing substantially in an insertion direction into the connector housing for positioning the shielding body.

According to the shield connector of the present disclosure, a configuration can be simplified while stable connection to the external GND member is enabled.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shield connector in one embodiment.

FIG. 2 is a section of the shield connector in the embodiment.

FIG. 3 is a partial exploded perspective view of a shielded cable in the embodiment.

FIG. 4 is an exploded perspective view of the shield connector in the embodiment.

FIG. 5 is a section of the shield connector in the embodiment.

FIG. 6 is a side view of a shielding body in the embodiment.

FIG. 7 is a front view of the shielding body in the embodiment.

FIG. 8 is a perspective view partly in section showing the configuration of the shield connector in the embodiment.

FIG. 9 is a partial section before crimping showing the shielded cable in the embodiment.

FIG. 10 is a partial section after crimping showing the shielded cable in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### (Configuration of Shield Connector 1)

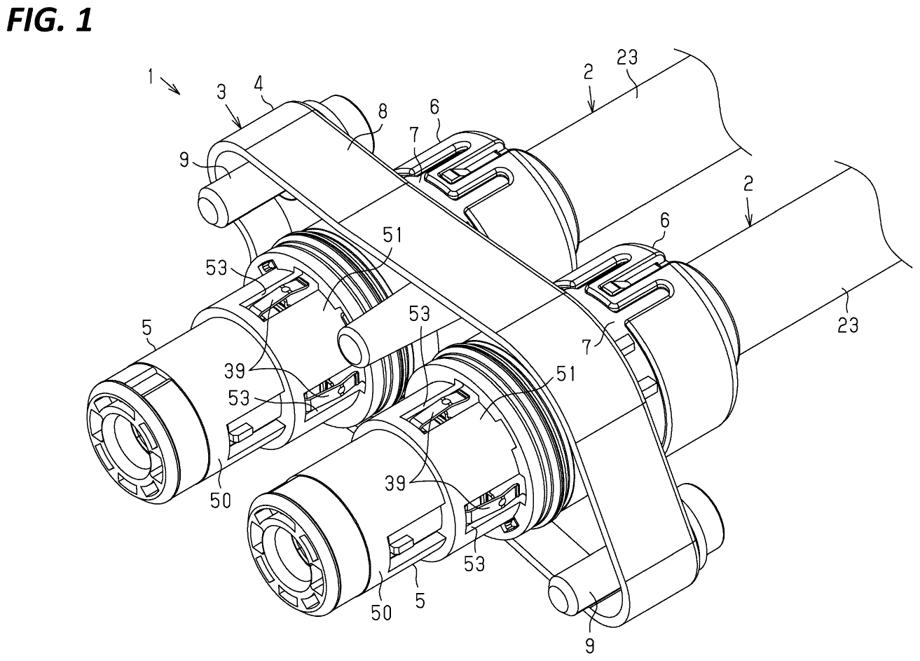

As shown in FIG. 1, a shield connector 1 is provided with one or more shielded cables 2 and/or a connector assembly 3 for attaching the one or more shielded cables 2 to a connection destination.

The connector assembly 3 is provided with a connector housing 4, one or more caps 5 attached to the one or more tips of the shielded cable(s) 2 and/or one or more rear holders 6 for at least partly covering part (e.g. the back surface) of the connector housing 4.

The connector housing 4 particularly includes one or more tube portions 7, into which the respective shielded cable(s) 2 at least partly is/are inserted, and/or a receptacle 8 to be fixed to the connection destination.

The receptacle 8 particularly is fixed to the connection destination by one or more, particularly a plurality of (two are shown in FIG. 1) clasps 9. The clasps 9 are, for example, bolts.

In this embodiment, a plurality of the shielded cables 2 specifically are provided side by side. A total of two shielded cables 2 of the embodiment are provided on a positive terminal side and a negative terminal side.

Note that since both of these shielded cables 2 have the same structure, only the shielded cable 2 on one side is described.

The cap 5 and/or the rear holder 6 particularly are provided for each shielded cable 2. The cap 5 is, for example, formed into a substantially hollow cylindrical shape.

The rear holder 6 particularly is so shaped that the shielded cable 2 is pulled out from the back surface of the tube portion 7 of the connector housing 4 while holding the shielded cable 2.

The rear holder 6 particularly is or is to be fixed to the connector housing 4, for example, by a locking structure.

### (Configuration of Shielded Cable 2)

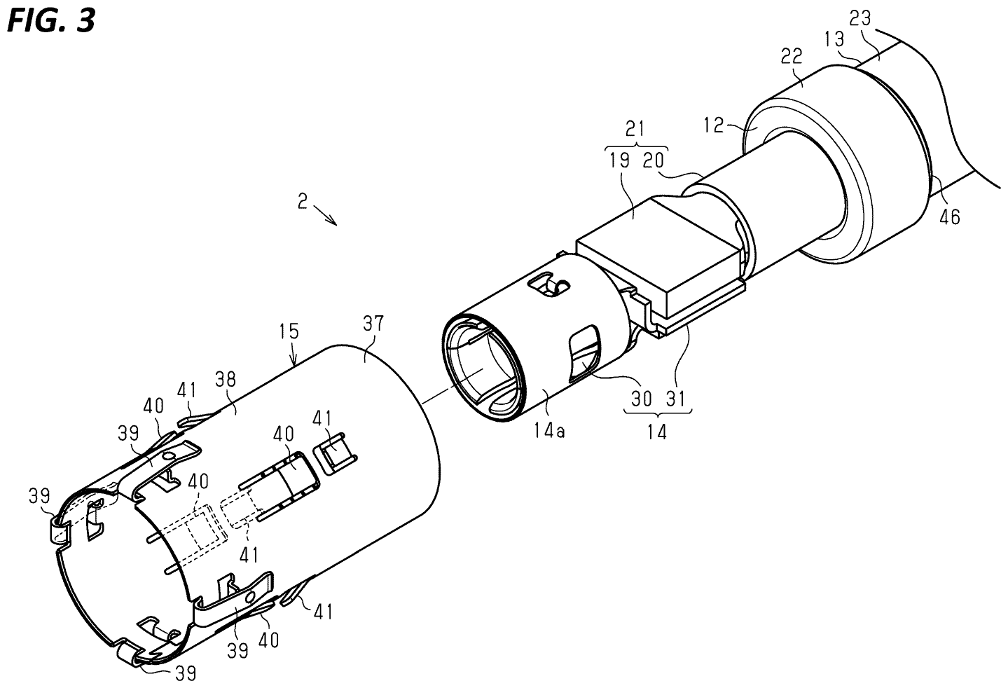

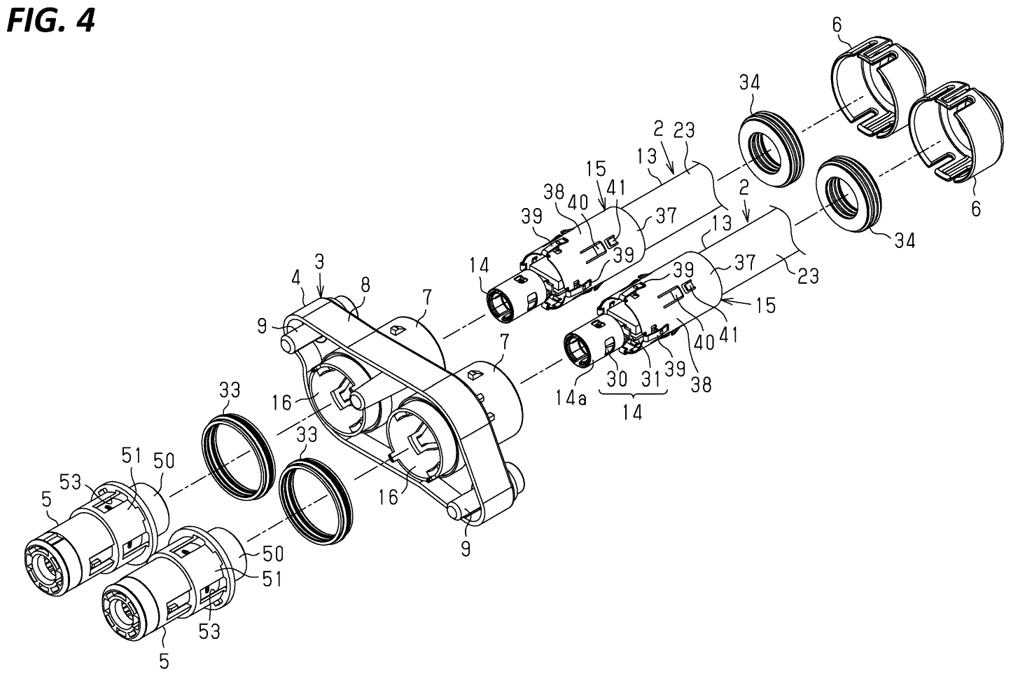

As shown in FIGS. 3 and 4, the shielded cable 2 is provided with a shielded cable body 13 particularly including a shield member 12 (see FIG. 3) for shielding noise, an electrical terminal 14 mounted on (particularly the tip of) the shielded cable body 13 and/or a tubular shielding body 15 to be connected to the shield member 12.

The shielded cable 2 particularly is or is to be mounted into the connector housing 4 by at least partly inserting the shielding body 15 into a hole 16 (see FIG. 4) of the tube portion 7.

As shown in FIG. 3, the shielded cable body 13 particularly is provided with at least one wire member 21 including a core wire 19 and/or an insulation coating 20.

The wire member 21 particularly includes, for example, the core wire 19 constituted by a conductor and the insulation coating 20 at least partly covering the outer periphery of the core wire 19.

The wire member 21 is, for example, a high-voltage wire corresponding to a high voltage and a large current.

The core wire 19 is, for example, a stranded wire formed by twisting a plurality of metal strands or a single core wire constituted by one columnar conductive (e.g. metal) bar having a solid structure inside.

The core wire 19 may be, for example, a combination of a plurality of types of conductors such as a stranded wire and a single core wire.

A copper-based or aluminum-based metal material is, for example, used as a material of the core wire 19.

The insulation coating 20 covers, for example, the outer peripheral surface of the core wire 19 particularly over an entire circumference.

The insulation coating 20 is, for example, made of an insulating material such as a synthetic resin. A synthetic resin mainly containing a polyolefin-based resin such as cross-linked polyethylene or cross-linked polypropylene particularly is used as a material of the insulation coating 20.

One type of material may be singly used or two or more types of materials may be used in appropriate combination as the material of the insulation coating 20.

The shield member 12 is, for example, a braid (braided wire) formed by braiding thin metal wires. Alternatively or additionally, the shield member 12 may be or comprise a shield layer made of a conductive material.

The shield member 12 particularly includes a folded portion 22 formed by folding the shield member 12 in an end part of the shield member 12.

In particular, the shielded cable body 13 first includes a covering member 23 at least partly covering the outer periphery of the shield member 12. The covering member 23 is, for example, a protective coating made of resin.

The folded portion 22 particularly is folded to cover the outer periphery of (particularly a tip part of) the covering member 23.

### (Configuration of Mating Connector 26)

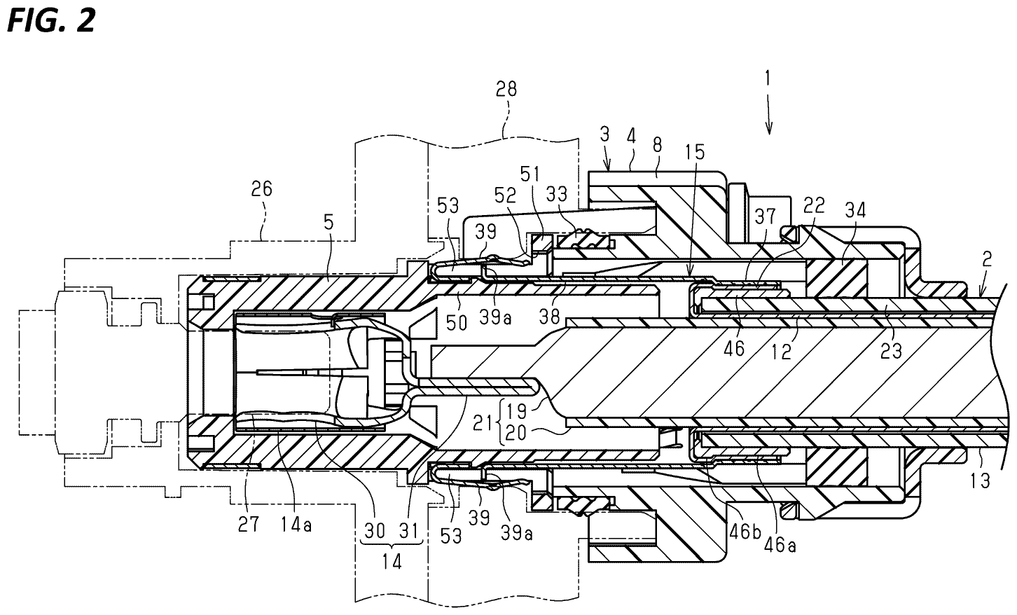

As shown in FIG. 2, the connector assembly 3 (connector housing 4) is connected or connectable to a mating connector 26 particularly as a connection destination of the shield connector 1.

The mating connector 26 includes one or more mating connector terminals 27 to be connected to the one or more electrical terminals 14.

Further, the mating connector 26 particularly includes an external ground (GND) member 28 to be electrically connected to the shielding body 15.

The external GND member 28 may be made of a conductive (e.g. metal) material and/or have inner peripheral surfaces substantially facing the outer peripheral surface(s) of the one or more shielding bodies 15.

Note that the external GND member 28 may, for example, double as a metal case of an electrical device.

### (Configuration of Electrical Terminal 14)

The electrical terminal 14 particularly includes a terminal body 30 to be connected to the mating connector terminal 27 of the mating connector 26 and/or a terminal end part 31 fixed or fixable to the core wire 19.

The terminal body 30 particularly is exposed to the outside of the shielding body 15.

The terminal end part 31 particularly at least partly is accommodated inside the shielding body 15. In this embodiment, the electrical terminal 14 is formed such that the terminal body 30 substantially has a tubular shape and/or the terminal end part 31 substantially has a flat plate shape.

Note that a tube member 14a particularly is fixed to the electrical terminal 14 of this embodiment to at least partly cover the outer periphery of the terminal body 30. The electrical terminal 14 at least partly is accommodated inside the cap 5 when the cap 5 is attached. As just described, the cap 5 at least partly covers the electrical terminal 14.

### (Sealing Structure of Connector Assembly 3)

As shown in FIGS. 2 and 4, the connector housing 4 particularly is provided with a first sealing member 33 for sealing a gap between the connector housing 4 and the mating connector 26. The first sealing member 33 is, for example, a seal made of rubber.

The first sealing member 33 is, for example, mounted on the outer periphery of the tube portion 7 on a side where the cap 5 is fit.

A second sealing member 34 for sealing a gap between the shielded cable 2 and the connector housing 4 particularly is provided between the shielded cable 2 and the connector housing 4. The second sealing member 34 is, for example, a seal made of rubber.

The second sealing member 34 is, for example, arranged between the outer peripheral surface of the shielded cable 2 and the inner peripheral surface of the tube portion 7.

### (Configuration of Shielding Body 15)

As shown in FIGS. 2 to 6, the shielding body 15 particularly substantially is formed into a tubular shape particularly by a conductive (e.g. metal) plate material.

The shielding body 15 particularly includes a connection portion (particularly comprising a crimping portion 37) to be fixed to the folded portion 22 of the shield member 12 particularly by being crimped and/or a shell body portion 38 to be electrically connected to the external GND member 28 (see FIG. 2) particularly of the mating connector 26 with the electrical terminal 14 electrically connected to the mating connector terminal 27.

The shell body portion 38 includes one or more (particularly leaf) spring portions 39 capable of being deflected or pressed into contact with the external GND member 28.

As shown in FIG. 7, a plurality of (four in this embodiment) the leaf spring portions 39 particularly are provided and/or arranged at substantially equal angular intervals (90° in this embodiment) in a circumferential direction of the shell body portion 38.

The leaf spring portion 39 is, for example, formed into a cantilever shape.

In particular, the leaf spring portion 39 particularly is formed by folding a piece extending from an end part of the shell body portion 38, and resiliently deformable in a radial direction.

The leaf spring portion 39 particularly includes at least one contact point in the form of a (particularly substantially circular) projection to be brought into contact with the external GND member 28.

Further, the shell body portion 38 particularly is formed with one or more projection portions 39 capable of contacting the back surface(s) of the leaf spring portion(s) 39.

The projection portion 39a particularly is formed by cutting a part of the shell body portion 38 and bending, embossing and/or folding a cut part.

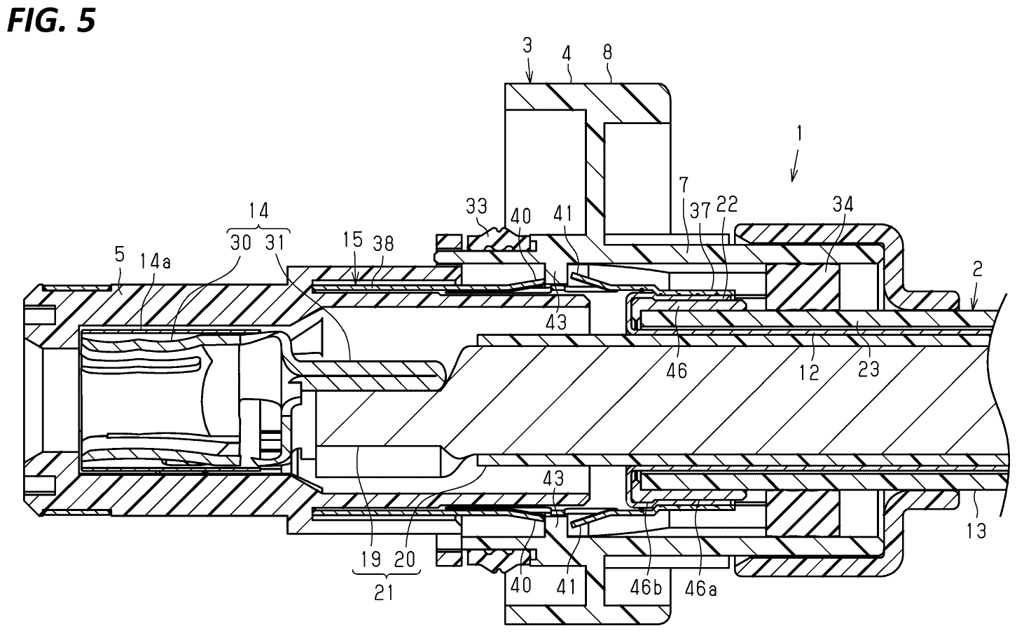

As shown in FIG. 5, the shell body portion 38 particularly includes one or more engaging portions 40 engageable with the connector housing 4 so as not to come out from the connector housing 4 while being mounted in the connector housing 4.

As shown in FIG. 7, a plurality of (four in this embodiment) engaging portions 40 particularly are provided on (particularly the outer peripheral surface of) the shell body portion 38.

The engaging portions 40 particularly are arranged at substantially equal angular intervals (90° in this embodiment) in the circumferential direction of the shell body portion 38.

Further, the engaging portions 40 of this embodiment particularly are provided at positions shifted by about 45° from the leaf spring portions 39 in the circumferential direction of the shell body portion 38.

The engaging portion 40 particularly is formed into a protruding shape having a slope inclined downward or inward in an insertion direction (leftward direction in FIG. 5) of the shielding body 15 into the connector housing 4.

Specifically, as shown in FIG. 5, the shell body portion particularly 38 includes one or more positioning portions 41 engageable with the connector housing substantially in the insertion direction (leftward direction in FIG. 5) into the connector housing 4 for positioning the shielding body 15 when being mounted into the connector housing 4.

As shown in FIG. 7, a plurality of (four in this embodiment) the positioning portions 41 particularly are provided on the outer peripheral surface of the shell body portion 38.

The positioning portions 41 particularly are arranged at substantially equal angular intervals (90° in this embodiment) in the circumferential direction of the shell body portion 38.

Further, the positioning portions 41 of this embodiment particularly are provided at the substantially same positions as the engaging portions 40 in the circumferential direction of the shell body portion 38.

The positioning portion 41 particularly is formed into a protruding shape having a slope inclined upward or inward in the insertion direction (leftward direction in FIG. 5) of the shielding body 15 into the connector housing 4.

On the other hand, as shown in FIG. 5, the connector housing 4 is formed with one or more protrusions 43 to be engaged with the one or more engaging portions 40 and/or the one or more positioning portions 41 of the shell body portion 38. The one or more protrusions 43 are, for example, formed on the inner peripheral surface of the tube portion 7.

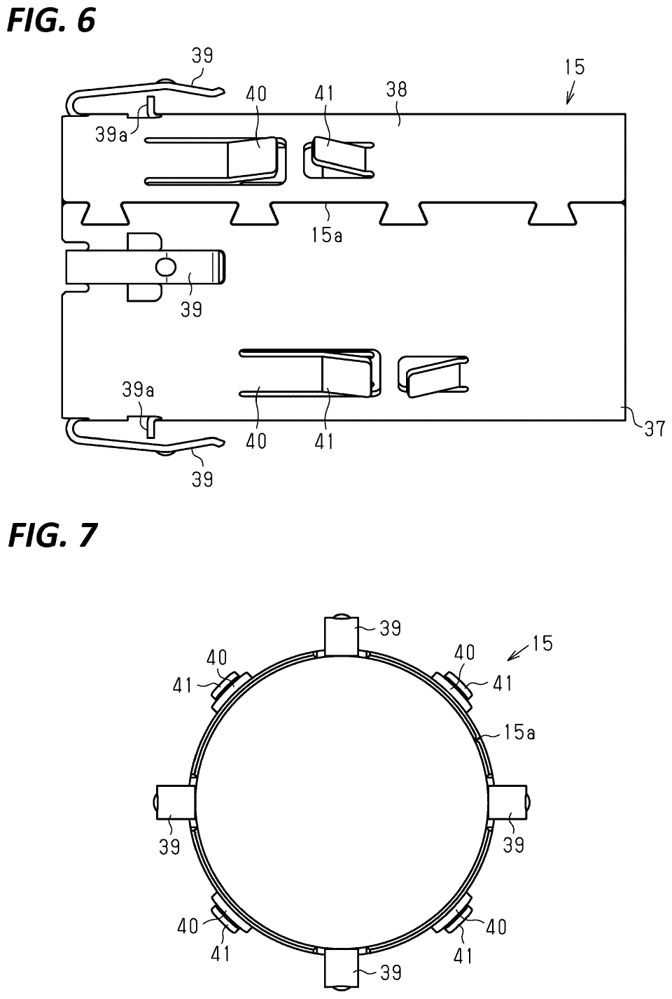

Further, as shown in FIG. 6, the shielding body 15 particularly includes at least one fitting portion 15a, where end parts of the conductive (e.g. metal) plate material are connected, in a circumference part.

Note that the fitting portion 15a of this embodiment particularly prevents the end part(s) of the conductive (metal) plate from being separated by one or more engaging recesses and one or more engaging protrusions engaged with each other.

The (particularly leaf) spring portion(s) 39, the engaging portion(s) 40 and/or the positioning portion(s) 41 are provided at position(s) not overlapping the fitting portion 15a in the circumferential direction. In other words, the (leaf) spring portion(s) 39, the engaging portion(s) 40 and the positioning portion(s) 41 are provided in parts where the fitting portion 15a is not arranged in the circumferential direction of the shell body portion 38.

That is, the fitting portion 15a particularly is provided between the leaf spring portions 39, between the engaging portions 40 and/or between the positioning portions 41 in the circumferential direction of the shell body portion 38.

### (Configuration of Underlay Ring 46)

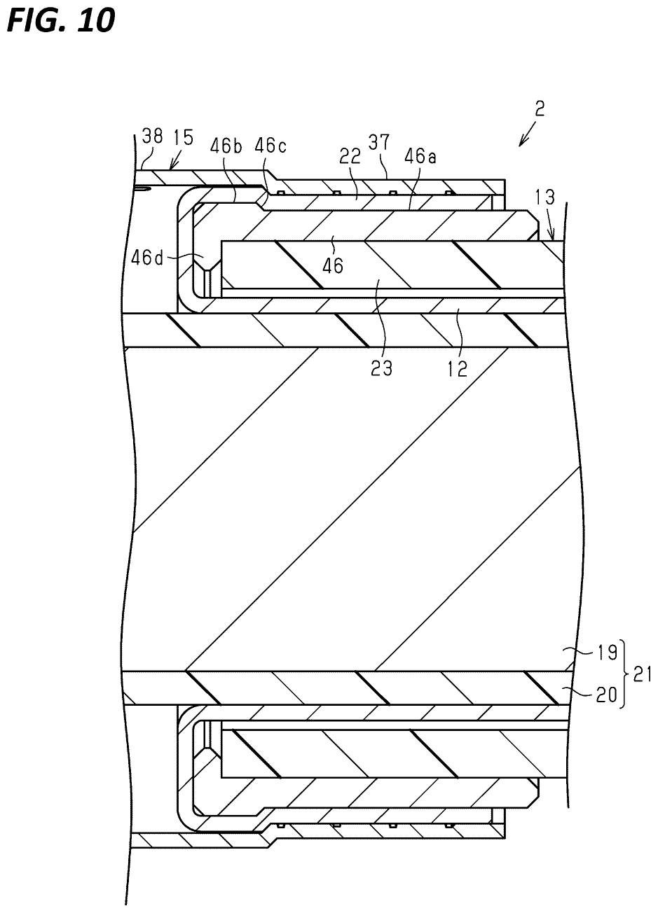

As shown in FIGS. 2 and 10, the shielded cable 2 particularly is provided with an underlay ring 46 for at least partly covering the outer periphery of the covering member 23 on (particularly a tip part of) the covering member 23, the outer periphery of the underlay ring 46 particularly being at least partly covered by the folded portion 22 of the shield member 12.

The underlay ring 46 is, for example, made of a conductive material such as metal.

In this way, the connecting portion (particularly the crimping portion 37) of the shielding body 15 is connected (particularly crimped) to at least partly sandwich the folded portion 22 between the crimping portion 37 and the underlay ring 46.

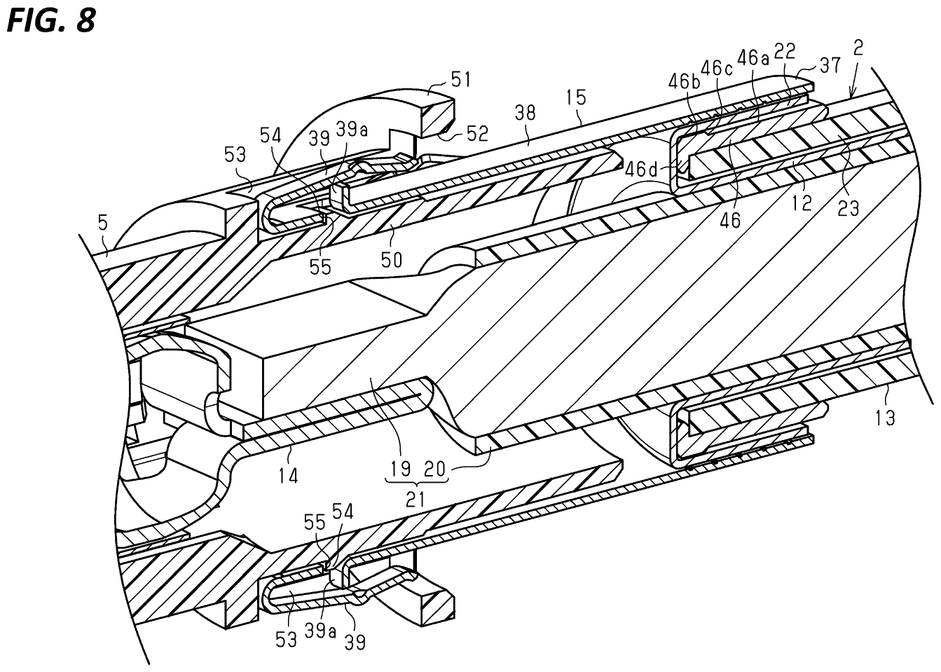

As shown in FIGS. 8 to 10, the underlay ring 46 particularly includes an underlay body portion 46a e.g. provided at a position substantially corresponding to the crimping portion 37 in a front-rear direction and/or a large-diameter portion 46b e.g. provided at a position substantially corresponding to a boundary between the crimping portion 37 and the shell body portion 38 and particularly having a larger diameter than the underlay body portion 46a.

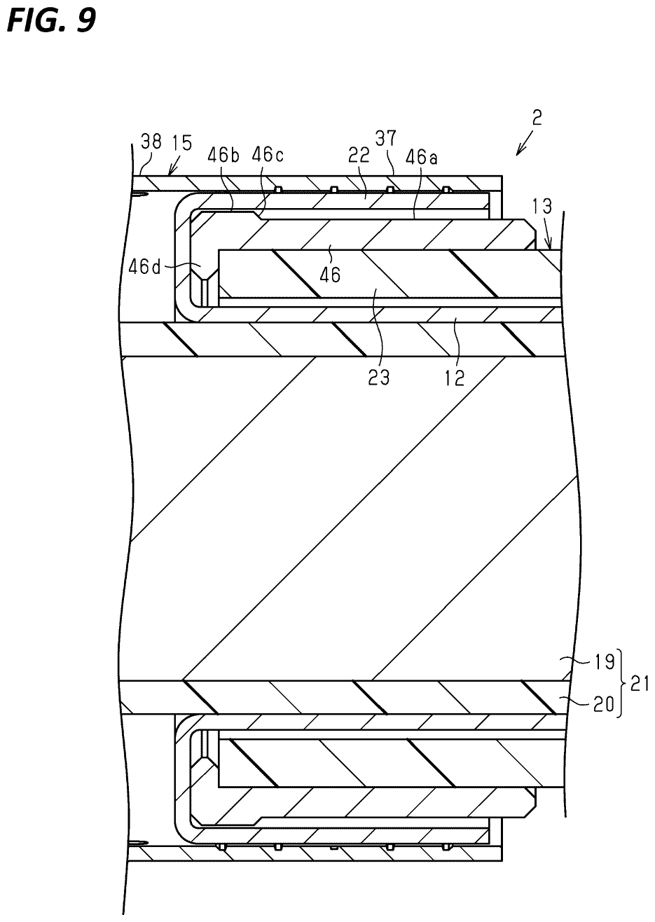

Note that FIGS. 8 and 9 show the crimping portion 37 in a state before connection (e.g. crimping).

The diameter of the crimping portion 37 in the state before crimping particularly is equal to that of the shell body portion 38.

Further, the underlay ring 46 particularly includes an inclined portion 46c having a diameter gradually reduced from the large-diameter portion 46b toward the underlay body portion 46a.

Further, the underlay body portion 46a particularly is set to have such a length as project further outward than end parts of the folded portion 22 and/or the crimping portion 37.

In other words, an end part (right end part in FIG. 10) of the underlay body portion 46a particularly is exposed while projecting out from the folded portion 22 and the crimping portion 37.

Further, the tip of the large-diameter portion 46b particularly includes an inward extending portion 46d to be substantially hooked to an end part of the covering member 23 on an end part (left end part in FIG. 10) thereof.

Specifically, the crimping portion 37 of the shielding body 15 particularly is crimped to the underlay ring 46 configured as described above to enter a state shown in FIG. 10 from a state shown in FIG. 9 by applying a pressure from a radially outer side of the underlay body portion 46a by a die or the like.

### (Function of Cap 5)

As shown in FIGS. 2 and 8, the cap 5 particularly includes a cap body 50 for at least partly accommodating the electrical terminal 14 of the shielded cable 2 and/or an outer peripheral wall 51 arranged on a radially outer side of the cap body 50 with a specified (predetermined or predeterminable) space formed therebetween.

The cap body 50 is, for example, formed into a hollow cylindrical shape.

The outer peripheral wall 51 particularly is circumferentially formed around the cap body 50.

Specifically, the shielding body 15 at least partly is inserted into a gap 52 between the cap body 50 and the outer peripheral wall 51 when being mounted into the connector housing 4.

As shown in FIG. 1, the outer peripheral wall 51 of the cap 5 is formed with one or more holes 53 for substantially exposing the one or more leaf spring portions 39 to outside.

Further, as shown in FIG. 8, one or more projections 54 to be engaged with the shielding body 15 are formed on the outer peripheral surface of the cap body 50.

The shielding body 15 particularly is formed with one or more cuts 55 to be engaged with the one or more projections 54.

The cuts 55 are, for example, through holes formed in providing the projection portions 39a.

The cap body 50 particularly at least partly is arranged between the electrical terminal 14 and the shielding body 15 with the cap 5 attached to the shielding body 15, thereby insulating the electrical terminal 14 and the shielding body 15.

### Functions of Embodiment

Next, exemplary functions of this embodiment are described.

As shown in FIG. 9, with the connecting portion (particularly the crimping portion 37) of the shielding body 15 arranged on the outer side of the folded portion 22 at least partly covering the outer periphery of the underlay ring 46, the connecting portion (particularly the crimping portion 37) is connected, particularly crimped by clamping and swaging the outer periphery of the crimping portion 37 by a die.

Swaging using a press die is, for example, used to crimp the crimping portion 37.

At this time, a pressure particularly is applied from the radially outer side of the underlay body portion 46a and/or substantially no pressure is applied from a radially outer side of the large-diameter portion 46b.

Then, as shown in FIG. 10, the connecting portion (particularly crimping portion 37) is fixed to the outside of the folded portion 22 while the folded portion 22 is sandwiched by the underlay ring 46 and the connecting portion (particularly the crimping portion 37).

In this way, the shielding body 15 particularly is fixed to the shielded cable body 13 while being electrically connected to the folded portion 22.

Specifically, during this crimping, the crimping portion 37 particularly is deformed to make the diameter thereof smaller than that of the shell body portion 38. At this time, the shell body portion 38 may be distorted in conjunction with the deformation of the crimping portion 37, for example, if the underlay ring 46 does not include the large-diameter portion 46b.

However, such a distortion particularly is suppressed by the large-diameter portion 46b in this embodiment.

After the shielded cable 2 is manufactured by mounting the shielding body 15 on the shielded cable body 13, this shielded cable 2 is or can be mounted into the connector housing 4.

Specifically, the shielded cable 2 at least partly is inserted into the hole 16 of the connector housing 4 (see FIG. 4). This insertion particularly is performed until the one or more positioning portions 41 substantially come into contact with the protrusions 43 of the connector housing 4 (see FIG. 5).

Further, with the shielded cable 2 at least partly inserted to the back of the hole 16, the one or more engaging portions 40 are hooked to the one or more protrusions 43, whereby the shielded cable 2 is retained.

In this way, the shielding body 15, i.e. the shielded cable 2, particularly is fixed to the connector housing 4.

Subsequently, the cap 5 is or can be attached to the shielded cable 2 mounted into the connector housing 4.

At this time, the cap 5 particularly is so attached to the shielded cable 2 that the shielding body 15 at least partly is inserted into the gap 52.

This insertion particularly is performed until the one or more projections 54 of the cap 5 are engaged with the one or more cuts 55 of the shielding body 15 while the one or more (leaf) spring portions 39 of the shielding body 15 substantially are located in the hole 53 of the (leaf) spring portions 39.

In the above way, the connector assembly 3 is assembled.

Then, when the connector assembly 3 particularly is connected to the mating connector 26 as shown in FIG. 2, the one or more electrical terminals 14 are electrically connected to the one or more mating connector terminals 27.

Further, in this state, the one or more (particularly leaf) spring portions 39 are pressed into contact with the inner peripheral surface of the external GND member 28, whereby the shielding body 15 is electrically connected to the external GND member 28.

### Effects of Embodiment

Next, effects of the above embodiment are described below.

(1) Since particularly being formed substantially into a tubular shape by the conductive (particularly metal) plate material, the shielding body 15 can be easily manufactured, for example, as compared to the case where the shielding body 15 is a cutting component.

Further, since the shielding body 15 particularly includes the connecting portion (particularly the crimping portion 37) to be connected (particularly crimped or deformed) to at least partly sandwich the folded portion 22 between the underlay ring 46 and the connecting portion (particularly crimping portion 37) and the shell body portion 38 particularly formed with the one or more (leaf) spring portions 39 capable of being pressed into contact with the external GND member 28, the number of components is smaller, for example, as compared to a configuration including a separate wave spring washer.

Thus, the shielded cable 2 can have a simple configuration.

Since the underlay ring 46 particularly includes the large-diameter portion 46b at the position substantially corresponding to the boundary between the connecting portion (particularly the crimping portion 37) and the shell body portion 38 and having a larger diameter than the underlay body portion 46a, the distortion of the shell body portion 38 is suppressed particularly when the crimping portion 37 is crimped. Thus, the one or more (particularly leaf) spring portions 39 formed on the shell body portion 38 can also be kept in proper shape.

As a result, the shielding body 15 can be stably connected to the external GND member 28.

Further, the folded portion 22 and the crimping portion 37 particularly are easily hooked to a step between the large-diameter portion 46b and the underlay body portion 46a, whereby the detachment of the underlay ring 46 is suppressed.

That is, a fixing force of the crimping portion 37 is improved by the large-diameter portion 46b.

(2) Since the underlay ring 46 particularly includes the inclined portion 46c having the diameter gradually reduced from the large-diameter portion 46b toward the underlay body portion 46a, the shield member 12 is less likely to be damaged, for example, as compared to a configuration not including the inclined portion 46c.

That is, with an underlay ring not including the inclined portion 46c, the shield member 12 may be damaged by a corner of the large-diameter portion 46b. However, this can be suppressed.

(3) Since the underlay body portion 46a particularly is set to have such a length as to project further outward than the end part(s) of the folded portion 22 and the connecting portion (particularly the crimping portion 37), the position of the underlay body portion 46a can be grasped from outside. Thus, it can be prevented that a pressure is applied to a part corresponding to the large-diameter portion 46b, for example, when the crimping portion 37 is crimped.

Therefore, the distortion of the shell body portion 38 due to the application of a pressure to the part corresponding to the large-diameter portion 46b is reduced or suppressed.

(4) Since the shell body portion 38 particularly includes the one or rmore engaging portions 40 engageable with the connector housing 4 not to come out from the connector housing 4, the detachment of the shielding body 15 from the connector housing 4 can be suppressed.

Since the distortion of the shell body portion 38 particularly is suppressed by the underlay ring 46 including the large-diameter portion 46b, the one or more engaging portions 40 can also be kept in proper shape.

As a result, the detachment of the shielding body 15 from the connector housing 4 is stably suppressed.

(5) Since the shell body portion 38 particularly includes the one or more positioning portions 41 engageable with the connector housing 4 in the insertion direction into the connector housing 4 for positioning the shielding body 15, the shielding body 15 can be arranged at an optimal mounting position.

Since the distortion of the shell body portion 38 particularly is suppressed by the underlay ring 46 including the large-diameter portion 46b, the one or more positioning portions 41 can also be kept in proper shape.

As a result, the shielding body 15 can be stably arranged at the optimal mounting position.

(6) The shielding body 15 particularly includes the fitting portion 15a, where the one or more end parts of the conductive (particularly metal) plate material are connected, in a circumferential part.

Since the particularly leaf) spring portions 39 particularly are provided at the positions substantially not overlapping the fitting portion 15a in the circumferential direction, the (leaf) spring portions 39 can be easily provided without being affected by the fitting portion 15a.

That is, if the (leaf) spring portion 39 particularly is provided substantially in a part where the fitting portion 15a is arranged, the (leaf) spring portion 39 is divided and has a complicated configuration. However, this can be avoided.

Further, since the one or more engaging portions 40 and the one or more positioning portions 41 particularly are also provided at the positions not overlapping the fitting portion 15a in the circumferential direction, these can be easily provided without being affected by the fitting portion 15a.

Accordingly, to enable the simplification of a configuration of a shield connector while enabling stable connection to an external GND member, rthere is provided particularly a shielded cable 2 comprising a shielded cable body 13 including a core wire 19, an insulation coating 20, a shield member 12 and a covering member 23, an underlay ring 46 for covering an outer periphery of the covering member 23 on a tip part of the covering member 23, an outer periphery of the underlay ring 46 being covered by a folded portion 22 of the shield member 12, and a shielding body 15 to be connected to the folded portion 22. The shielding body 15 includes a crimping portion 37 formed into a tubular shape by a metal plate material and to be crimped to sandwich the folded portion 22 by the underlay ring 46 and the crimping portion 37, and a shell body portion 38 formed with a leaf spring portion capable of being pressed into contact with an external GND member 28. The underlay ring 46 includes an underlay body portion 46a provided at a position corresponding to the crimping portion 37 and a large-diameter portion 46b provided at a position corresponding to a boundary between the crimping portion 37 and the shell body portion 38 and having a larger diameter than the underlay body portion 46a.

### Modifications

The above embodiment can be modified and carried out as follows. The above embodiment and the following modifications can be carried out in combination without technically contradicting each other.

Although the underlay ring 46 particularly includes the inclined portion 46c having the diameter gradually reduced from the large-diameter portion 46b toward the underlay body portion 46a in the above embodiment, there is no limitation to this and the inclined portion 46c may be, for example, not included.

That is, the large-diameter portion 46b and the underlay body portion 46a may be connected by a substantially flat surface extending straight in a radial direction.
Although the underlay body portion 46a particularly is set to have such a length as to project further outward than the end part(s) of the folded portion 22 and/or the connecting portion (particularly the crimping portion 37) in the above embodiment, there is no limitation to this and the underlay body portion 46a may be set to have such a length as not to project from the folded portion 22 and the connecting portion (particularly the crimping portion 37).

That is, the underlay body portion 46a may be set to have such a length as not to be exposed to outside from the folded portion 22 and the connecting portion (particularly the crimping portion 37).
Although the shell body portion 38 particularly includes the one or more engaging portions 40 engageable with the connector housing 4 so as not to come out from the connector housing 4 in the above embodiment, there is no limitation to this and the engaging portion(s) 40 may not be included.
Although the shell body portion 38 particularly includes the one or more positioning portions 41 engageable with the connector housing 4 substantially in the insertion direction into the connector housing 4 for positioning the shielding body 15 in the above embodiment, there is no limitation to this and the positioning portion(s) 41 may not be included.
Although the (particularly leaf) spring portions 39 particularly are provided at the positions substantially not overlapping the fitting portion 15a in the circumferential direction of the shell body portion 38, there is no limitation to this and the leaf spring portion 39 may be provided in the part where the fitting portion 15a is arranged.

Further, although the one or more engaging portions 40 particularly are provided at the respective positions substantially not overlapping the fitting portion 15a in the circumferential direction of the shell body portion 38, there is no limitation to this and the engaging portion 40 may be provided in the part where the fitting portion 15a is arranged.

Further, although the one or more positioning portions 41 particularly are provided at the respective positions substantially not overlapping the fitting portions 15a in the circumferential direction of the shell body portion 38, there is no limitation to this and the positioning portion 41 may be provided in the part where the fitting portion 15a is arranged.
The shape and number of the (particularly leaf) spring portions 39 of the above embodiment may be changed.

Further, the shape and number of the engaging portions 40 of the above embodiment may be changed.

Further, the shape and number of the positioning portions 41 of the above embodiment may be changed.
Although the shield member 12 particularly is a braided wire formed by braiding thin metal wires in the above embodiment, there is no limitation to this and the shield member 12 may be, for example, changed to another shield member such as a conductive layer such as a conductive foil e.g. an aluminum foil.
Although the electrical terminal 14 particularly is such that the terminal body 30 is exposed to the outside of the shielding body 15 in the above embodiment, there is no limitation to this and the terminal body 30 may be, for example, also arranged inside the shielding body 15.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield connector, comprising:
a shielded cable body including at least one core wire, an insulation coating for at least partly covering an outer periphery of the core wire, a shield member for at least partly covering an outer periphery of the insulation coating and a covering member for at least partly covering an outer periphery of the shield member;
at least one electrical terminal to be fixed to the core wire;
an underlay ring for at least partly covering an outer periphery of the covering member on a tip part of the covering member, an outer periphery of the underlay ring being covered by a folded portion of the shield member; and
a shielding body to be connected to the folded portion, the shielding body being electrically connectable to an external GND member,
the shielding body including a connecting portion substantially formed into a tubular shape by a conductive plate material, the connecting portion sandwiching the folded portion by the underlay ring and the connecting portion, and a shell body portion formed with at least one spring portion capable of being pressed into contact with the external GND member, and
the underlay ring including an underlay body portion provided at a position substantially corresponding to the connecting portion and a large-diameter portion provided at a position substantially corresponding to a boundary between the connecting portion and the shell body portion, the large-diameter portion having a larger diameter than the underlay body portion.

2. The shield connector according to claim 1, wherein the underlay ring includes an inclined portion having a diameter gradually reduced from the large-diameter portion toward the underlay body portion.

3. The shield connector according to claim 1, wherein the underlay body portion is set to have such a length as to project further outward than end part(s) of the folded portion and/or the connecting portion.

4. The shield connector according to claim 1, wherein:
the shielding body is mounted by being at least partly inserted into a connector housing, and
the shell body portion includes at least one engaging portion engageable with the connector housing so as not to come out from the connector housing, or
the shell body portion includes at least one positioning portion engageable with the connector housing substantially in an insertion direction into the connector housing for positioning the shielding body.

5. The shield connector according to claim 4, wherein, with the shielded cable at least partly inserted to a hole of the tube portion, the engaging portion is hooked to at least one respective protrusion of the housing, whereby the shielded cable is retained.

6. The shield connector according to claim 1, wherein:
the shielding body includes at least one fitting portion in a circumferential part, end parts of the conductive plate material being connected at the fitting portion, and
the spring portion particularly is provided at a position substantially not overlapping the fitting portion in a circumferential direction.

7. A shield connector assembly comprising a shield connector according to claim 1 and a mating connector including the external GND member to be electrically connected to the shielding body.

8. A shielded cable comprising:
a shielded cable body including at least one core wire, an insulation coating for at least partly covering an outer periphery of the core wire, a shield member for at least partly covering an outer periphery of the insulation coating and a covering member for at least partly covering an outer periphery of the shield member;
an underlay ring for at least partly covering an outer periphery of the covering member on a tip part of the covering member, an outer periphery of the underlay ring being covered by a folded portion of the shield member; and
a shielding body to be connected to the folded portion, the shielding body being electrically connectable to an external GND member,
the shielding body including a connecting portion substantially formed into a tubular shape by a conductive plate material, the connecting portion sandwiching the folded portion by the underlay ring and the connecting portion, and a shell body portion formed with at least one spring portion capable of being pressed into contact with the external GND member, and
the underlay ring including an underlay body portion provided at a position substantially corresponding to the connecting portion and a large-diameter portion provided at a position substantially corresponding to a boundary between the connecting portion and the shell body portion, the large-diameter portion having a larger diameter than the underlay body portion.

9. The shielded cable according to claim 8, wherein the underlay ring includes an inclined portion having a diameter gradually reduced from the large-diameter portion toward the underlay body portion, and/or wherein the underlay body portion is set to have such a length as to project further outward than end part(s) of the folded portion and/or the connecting portion.

10. The shielded cable according to claim 8, wherein:
the shielding body is mounted by being at least partly inserted into a connector housing, and
the shell body portion includes at least one engaging portion engageable with the connector housing so as not to come out from the connector housing, or
the shell body portion includes at least one positioning portion engageable with the connector housing substantially in an insertion direction into the connector housing for positioning the shielding body.
